(19) United States
(12) Patent Application Publication
(10) Pub. No.: US 2012/0191386 A1
(43) Pub. Date: Jul. 26, 2012

(54) Utility energy monitoring device

(76) Inventor: William Mark Acheson, Redmond, WA (US)

(21) Appl. No.: 13/011,884

(22) Filed: Jan. 22, 2011

(51) Int. Cl. G06F 19/00; G01D 7/02

(52) U.S. Cl. 702/61; 73/866.3

(57) ABSTRACT

This device is a utilities monitor. Said device displays current usage of utility resources being consumed and records and displays usage data. Said device receives utility usage data from sensors that are measuring utility (such as gas, water and/or electricity) usage data.

### FEDERALLY SPONSORED RESEARCH

Not Applicable

### SEQUENCE LISTING OR PROGRAM

Not Applicable

### BACKGROUND

### Field

This invention generally relates to a device which displays utility usage, trends and statistical analysis data.

### BACKGROUND OF THE INVENTION

### Prior Art

In most buildings utility companies have installed meters to measure utility usage. These meters are for the utility companies' purposes of measuring usage data, in order to charge their customers for utility usage.

Each utility measures only its utility usage at a particular location or building.

The utility customer currently sees a single utility's usage data, at the location of the utility company's selection. The customer does not have access at a location of their selection (remote from the utility meter) to current charges (cost), usage trends, or outage notifications.

U.S. Pat. No. 4,783,623 records the time of utility usage.

U.S. Pat. No. 4,757,456 provides for multiple accounts usage to be displayed on the same single utility meter.

Previous patents (e.g. U.S. Pat. No. 5,767,790) have been submitted showing mechanisms for a utility company to read and/or manage the utility usage data.

Patent application #20090201171 assists a utility company with monitoring utility usage via a computer network.

The disadvantages to a utility customer of these references are:
a) that none of these provide the customer usage data of more than one utility in a central location
b) the customer has no current charges accrued information available to them
c) the customer does not have a means to be made aware of and monitor an outage of their utility service
d) the customer cannot view historical utility usage via a central device at a location of their choosing
e) the customer has no means to be alerted of increased usage levels of a given utility

### SUMMARY

The device proposed in this application obtains utility usage, trends, and statistical analysis from a plurality of utility usage meters and presents the information via said device.

### DRAWINGS

### Figures

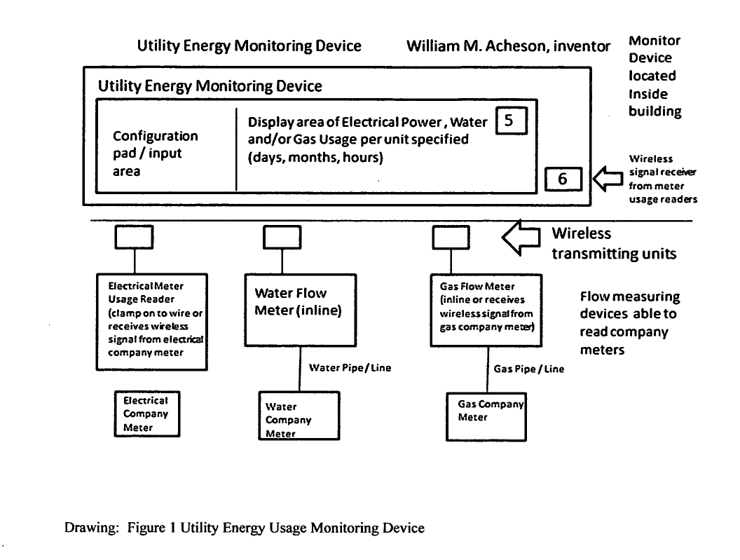

FIG. 1 is a system level view of a first embodiment of my invention, showing how the device obtains the utility meter data.

### REFERENCE NUMERALS

5 Data display area

6 Wireless receiver of utility usage data

### DESCRIPTION

### FIG. 1—First Embodiment

The embodiment of the utility energy monitoring device is shown in FIG. 1. The device has a panel, as in reference 5, on the front which is capable of displaying data in both numerical and graphical format. A typical material to be used for this panel would be an LCD (liquid crystal display) panel. The device exterior or casing would typically be formed from plastic, however it could be made of any other material such as metal.

The device receives utility usage data via reference 6, a wireless signal receiver. This wireless signal receiver is tuned to receive at the frequency the utility meters are being read at, thereby collecting utility usage information.

### CONCLUSION, RAMIFICATIONS, AND SCOPE

Possible novel features:
1. Multiple utilities' usage data available in an easily readable, central location is believed to be entirely new.

2. Provides user real-time utility usage data

3. Emergency alert of utility outages and/or breakages is believed to be entirely new.

4. Programmable to alert user of use levels

5. Device is readable by a user (utility customer) at a location other than visually from the utility meter installed by a utility company

Accordingly the reader will see that, according to one embodiment of the invention, I have provided relevant data.

While the above description contains many specificities, these should not be construed as limitations on the scope of any embodiment, but as exemplifications of the presently preferred embodiments thereof. Many other ramifications and variations are possible within the teachings of the various embodiments. For example:

### Ramifications

1. Visual display of utility usage
2. Time period of displayed usage can be adjusted
3. Notification of utility usage changes based on the monitor's data it had previously collected
4. Provides utility usage information for the user's decision/actions

Thus the scope of the invention should be determined by the appended claims and their legal equivalents and not by the examples given.

### Specification

Electrical data signals from utility meters received into said device.

Device reads usage information from the utility electricity meter, which transmits at 60 Hz. Electricity Meter generates signals of 0-200 amps or 0-0.5 Volt. This usage data converts into KW/hr.

Gas & Water Meters generate 0-0.1 Volt from each flow meter

Gas and/or water usage data is in Gal/minute or Liter/minute.

Water meter transmits data from a tracer wire.

Circuit board design feeds into screen viewable by utility customer.

Display screen is programmable by the utility customer.

### Summary

In accordance with one embodiment, a device which presents utility usage information displaying utility usage levels, usage trends, and historical analysis for a plurality of utilities in a centralized location.

I claim:

1. A device for gathering and presenting utility information.

2. The closure of claim 1 wherein said device provides means for providing said information relating to utility usage, trends, alerts of changes in usage levels and statistical analysis of usage.

3. The closure of claim 1 wherein said device utilizes a plurality of measuring devices with means to obtain data from utility meters.

4. Said device for gathering and presenting utility information comprising means for display of said information

5. Whereby said display is capable of displaying numerical data remote from the utility meter
